(19) United States
(12) Patent Application Publication
(10) Pub. No.: US 2026/0151895 A1
(43) Pub. Date: Jun. 4, 2026

(54) FOLDABLE MULTI-AXIS ROBOTIC SYSTEM WITH INTEGRATED VISION AND NAVIGATION

(71) Applicant: Dexmate Inc., Santa Clara, CA (US)

(72) Inventors: Ruitao Huang, Shenzhen (CN); Yuzhe Qin, Santa Clara, CA (US); Tao Chen, Fremont, CA (US)

(21) Appl. No.: 19/192,011

(22) Filed: Apr. 28, 2025

(30) Foreign Application Priority Data
Dec. 3, 2024 (CN) 202422971287.4
Dec. 6, 2024 (CN) 202423012831.9
Dec. 9, 2024 (CN) 202423024041.2

(51) Int. Cl. B25J 5/00; B60L 50/60; B62D 63/04

(52) U.S. Cl. CPC B25J 5/007; B60L 50/60; B62D 63/04

(57) ABSTRACT

A robotic system is provided. In some embodiments, the robotic system integrates a wheel base, height adjustment mechanism, and gimbal assembly to provide enhanced mobility and adaptability for various applications. The wheel base features both an active wheel assembly, which drives the robot, and a passive wheel assembly that aids in weight distribution, allowing for multidirectional movement while maintaining stability. The height adjustment system includes a lifting structure with multiple connection assemblies capable of rotational movement, enabling the robot to transition between compact and extended states for versatile height adjustments. Additionally, the gimbal assembly comprises a support body and a gimbal module that facilitates the module's transition between flat and vertical positions. Together, these components create a robust and flexible robotic platform suitable for diverse tasks in industrial settings and challenging environments.

### FIELD OF THE INVENTION

The present Application relates to robotics and automation, more particular to robots that can move around in their environment having a omnidirectional wheel base, obstacle avoidance system, telescopic lifting structure, and/or a foldable gimbal assembly.

### BACKGROUND OF THE INVENTION

General-purpose robots are versatile machines designed to perform a wide range of tasks across various applications. Unlike specialized robots built for specific functions, these robots can be reprogrammed and adapted to different roles, making them highly flexible and cost-effective. Key characteristics include their adaptability to multiple projects, from assembly and welding to painting and packaging, and their ability to be easily redeployed when needs change. This versatility makes them particularly valuable in manufacturing and industrial settings, where they can increase production efficiency and relieve humans of dangerous or monotonous work.

As technology advances, general-purpose robots are becoming increasingly sophisticated, incorporating features such as AI-based software, smart sensors, and data analytics. This evolution is expanding their capabilities and potential applications across various industries. They offer advantages such as reduced equipment requirements, as one robot can perform multiple functions, and the potential for lights-out manufacturing in fully automated production environments. With their growing ability to work alongside humans in collaborative settings, general-purpose robots are poised to play an even more significant role in shaping the future of automation and industry.

Wheeled base robots are a fundamental type of mobile robot that use wheels for locomotion. These robots typically consist of a chassis equipped with two or more wheels, which can be driven independently to control movement and direction. The simplicity of their design makes them easier to build, program, and maintain compared to other types of mobile robots, such as those with legs or tracks.

### SUMMARY OF THE INVENTION

In various embodiments, a general-purpose robotic system is provided. The robotic system, in those embodiments, is designed as a versatile mobile platform that integrates omnidirectional movement, adjustable height, and a multi-angle vision system. Such a design enables the robotic system to be compact and portable, stable, and adaptable to various tasks and environments. The robotic system, in those embodiments, employs a combination of mechanical, electrical, and visual components to achieve these goals.

In some embodiments, this robotic system has three parts: a wheel base, a height adjustment system, and a gimbal assembly. The wheel base has two types of wheels: an active wheel assembly that drives the robot and a passive wheel assembly that helps distribute its weight. This setup allows the robot to move in different directions easily. Importantly, the design ensures that the active wheels are positioned at the same distance from the passive wheels, which helps keep the robot stable and maneuverable.

The height adjustment system includes a lifting structure made up of several connection assemblies that can rotate. These assemblies consist of a first, second, and third connection assembly, each allowing for different types of rotation. This design enables the lifting structure to change between a compact state and an extended state, making it easy to adjust the robot's height as needed. Additionally, the gimbal assembly features a support body and a gimbal module that allows the gimbal module to move between flat and vertical positions, adding to the robot's flexibility.

Overall, this robotic system is designed to be stable and adaptable. Its components work together to allow for smooth movement and height adjustments. With its combination of active and passive wheels, an adjustable height system, and a versatile gimbal assembly, this robot is well-suited for various tasks, from industrial applications to exploring challenging environments.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

FIG. 1 illustrates generally a robotic system in accordance with the present disclosure.

FIG. 2A illustrates an example of a wheel base of the robotic system shown in FIG. 1.

FIG. 2B illustrates a rear view of the wheel base shown in FIG. 2A.

FIG. 2C illustrates one example implementation of the wheel base shown in FIG. 1.

FIG. 2D illustrates another example implementation of the wheel base shown in FIG. 1

FIG. 2E illustrates a bottom view of the wheel base shown in FIG. 2A.

FIG. 2F illustrates another bottom view of the wheel base shown in FIG. 2A.

FIGS. 3A-3F illustrate an example of the height adjustment system shown in FIG. 1

FIGS. 4A-4F illustrate an example of the gimbal assembly shown in FIG. 1.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. For a particular repeated reference numeral, cross-reference may be made for its structure and/or function described and illustrated herein.

In various embodiments, a general-purpose robotic system is provided. The robotic system, in those embodiments, is designed as a versatile mobile platform that integrates omnidirectional movement, adjustable height, and a multi-angle vision system. Such a design enables the robotic system to be compact and portable, stable, and adaptable to various tasks and environments. The robotic system, in those embodiments, employs a combination of mechanical, electrical, and visual components to achieve these goals.

In some embodiments, a robotic system in accordance with the present disclosure has a wheel base, enabling the robotic system to move in multiple directions without needing to turn. In some embodiments, such a wheel base is achieved through two active wheels at the front and one passive wheel at the rear. In some embodiments, the active wheels are driven by an integrated hub motors that allows for independent steering, and the passive wheel is a free-rotating omnidirectional wheel for stability and maneuverability. In some embodiments, the wheel base is supported by a cross-bearing seat, which enhances the overall stability of the structure. In some embodiments, the steering mechanism for the wheel base includes a steering motor, a steering bracket, and a control encoder to allow for precise movement control. Still in some embodiments, the wheel base incorporates infrared sensors for obstacle avoidance, enhancing its autonomous navigation capabilities.

In some embodiments, the robotic system in accordance with the present disclosure incorporates a height adjustment system. In some embodiments, the height adjustment system has a multi-stage telescopic lifting structure for adjusting a height of the robotic system. In some embodiments, the lifting structure has nested components that are driven by multiple motors and has reduced amount of gears. In some embodiments, the lifting structure is designed to collapse compactly when not in in use so to reduce the overall size of the robotic system to be portable. In some embodiments, the lifting structure includes a multi-layer structure and an internal strengthening rib to ensure stability during lifting. In some embodiments, the different components of the lifting mechanism are connected by motorized modules and rotational joints, allowing it to extend and retract smoothly. In some embodiments, a rotation range of the different components of the lifting structure is up to 140 degrees to allow for an extensive range of motion.

In some embodiments, the robotic system in accordance with the present disclosure is equipped with a foldable gimbal assembly that houses a visual module. The gimbal assembly is designed to fold down into a storage compartment for protection, reducing the robot's overall size when not in use. In some embodiments, the gimbal assembly allows the robot to adjust its viewing angle both horizontally and vertically. In some embodiments, the gimbal assembly is driven by multiple motors and drivers to provide rotation. In some embodiments, the visual module includes a camera and other related electronics, and may be connected to a control board for image processing and system management. In some embodiments, the gimbal assembly includes a protective structure and fastening pieces to keep all components secure.

In some embodiments, the robotic system in accordance with the present disclosure has a control system that manages various mechanical and electrical components of the robotic system. The control system integrates motor control, sensor input, and communication protocol to control the robotic system. In some embodiments, the control system has a control board located within a visual module of the robotic system and is electrically connected to other parts of the robotic system. In some embodiments, power is provided to the robotic system by a battery.

In some embodiments, a frame of the robotic system in accordance with the present disclosure is constructed of durable materials, such as metal or high strength polymers, to ensure stability and durability. In some embodiments, various mechanical components of the robotic system are manufactured using precise machining process, allowing for a compact and robust design. In various embodiments, the robotic system uses a combination of fasteners, bearings, and connectors to assemble all parts.

Among various advantages provided by the robotic system in accordance with the present disclosure is a foldable design of a lifting structure and/or a gimble assembly that allows the robot to reduce its size when not in use, which enhances its portability and storage capacity. Another advantage of the robotic system in accordance with the present disclosure is a combination of omnidirectional mobility, height adjustment and/or a multi-angle vision systems to create a highly adaptable and versatile operational platform. Still another advantage of the robotic system in accordance with the present disclosure is a nested multi-layer design of lifting component and a protective structure for the gimbal assembly to enhance the robotic system's stability and durability. Other advantages are contemplated.

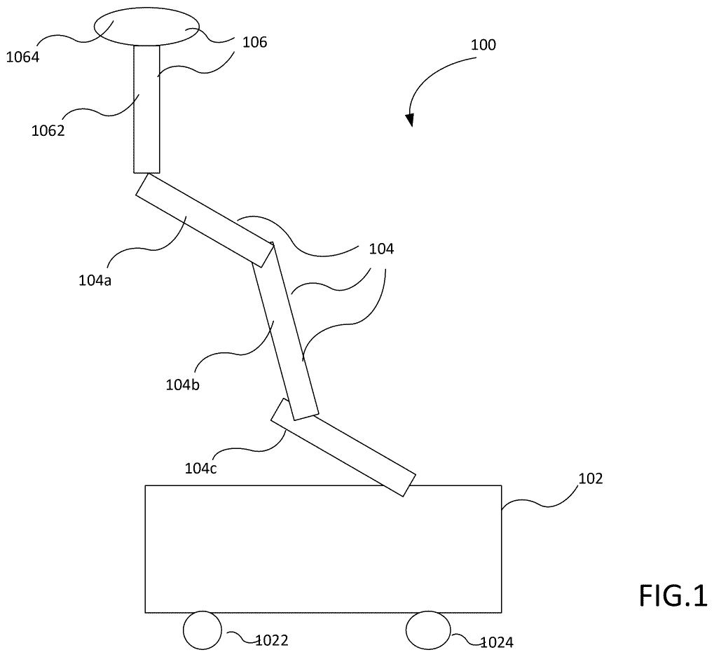

FIG. 1 illustrates a general drawing for an example robotic system 100 in accordance with the present disclosure. In this example, the robotic system 100 comprises a wheel base 102, a height adjustment system 104, a gimbal assembly 106, and/or any other components. The wheel base 102 comprises an active wheel assembly 1022 and a passive wheel assembly 1024. The active wheel assembly 1022 is configured to drive the robotic system 100, allowing it to move across various surfaces. The passive wheel assembly 1024 is configured to provide support and stability to the robotic system 100. It is positioned on the wheel base 102 to help distribute a weight of the wheel base 102 evenly, which is important for maintaining balance while the robot moves. In this example, the combination of the active wheel assembly 1022 and the passive wheel assembly 1024 enables the robotic system 100 to move all directions (omnidirectional movements) easily. The design of the wheel assemblies (which will be described in greater detail) improves a maneuverability of the robotic system 100 such that it is enabled to navigate complex environments effectively. The ability to move in any direction enhances the overall performance and efficiency of the robotic system 100.

In this example, the height adjustment system 104 comprises a three-stage telescopic structure designed to allow the robotic system 100 to alter its height. For achieving this, the height adjustment system 104 can have nested components that are driven by multiple motors to reduce a number of gears for the robotic system 100. In various embodiments, these components may include a first connecting component 104a, a second connecting component 104b, and a third connecting component 104c, as shown, which are linked through motorized modules and rotational joints, enabling smooth extension and retraction of the robotic system 100. When fully retracted, the robotic system 100 can fold into a horizontal position for compact storage, and when extended, the robotic system 100 can achieve an angle between 10 and 160 degrees. This allows the robotic system 100 to adjust its height for various tasks for various operations and to reduce its overall size when not in use.

The gimbal assembly 106 comprises a gimbal 1062 and a vision module 1064. The gimbal 1062 configured to provide multi-angle capabilities to facilitate a visual module 1064. The gimbal 1062 also has a foldable structure that allows the robotic system 100 to adjust its viewing angle both horizontally and vertically. In various embodiments, the gimbal 1062 comprise parts, including a support base, a first mount, a second mount and/or any other components. These components are connected by multiple drive units, which allow for a range of motion. The drive units can control the front-to-back flip of the first mount, enabling the gimbal 1062 to be either in a deployed or stowed position. The drive units can facilitate horizontal rotation of the second mount, allowing the gimbal 1062 to adjust its horizontal viewing angle. The drive units can control the front-to-back rotation of the gimbal 1062, enabling vertical, or pitch, adjustments. This combination of rotational movements allows the robotic system 100 to have a wide range of visual perspectives and improves its adaptability in various settings.

The vision module 1064 is positioned on top of the gimbal 1062 through the first and second mounts. In various embodiments, the vision module includes a camera and related electronic components. In some embodiments, the vision module 1064 has a control board located inside the vison module 1064. The vision module 1064 allows the robotic system 100 to capture images and perceive its environment. It provides the robotic system 100 an ability to perform complex tasks, such as navigation, object recognition, and monitoring.

With an example robotic system 100 in accordance with the present disclosure having been generally described, attention is now directed to various subsequent drawings, where the wheel base 102, the height adjustment system 104, and the gimbal assembly 106 are described in further details.

### Wheel Base

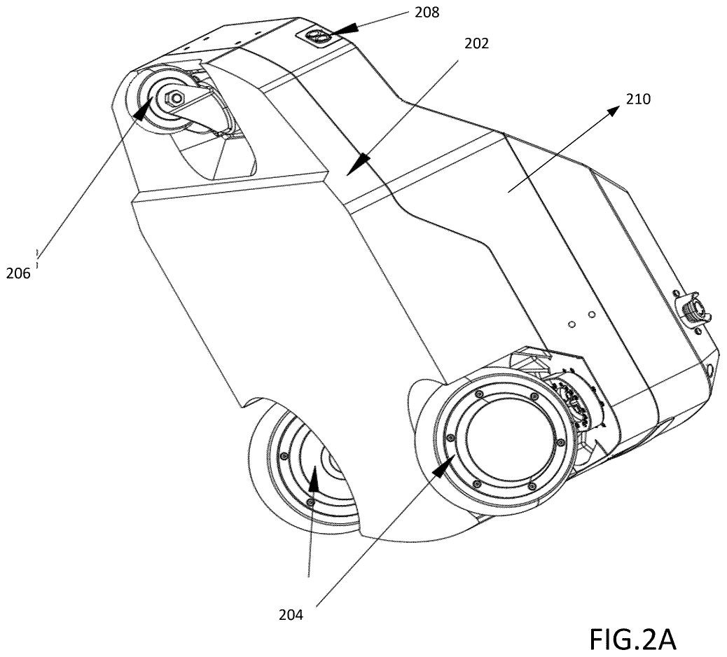

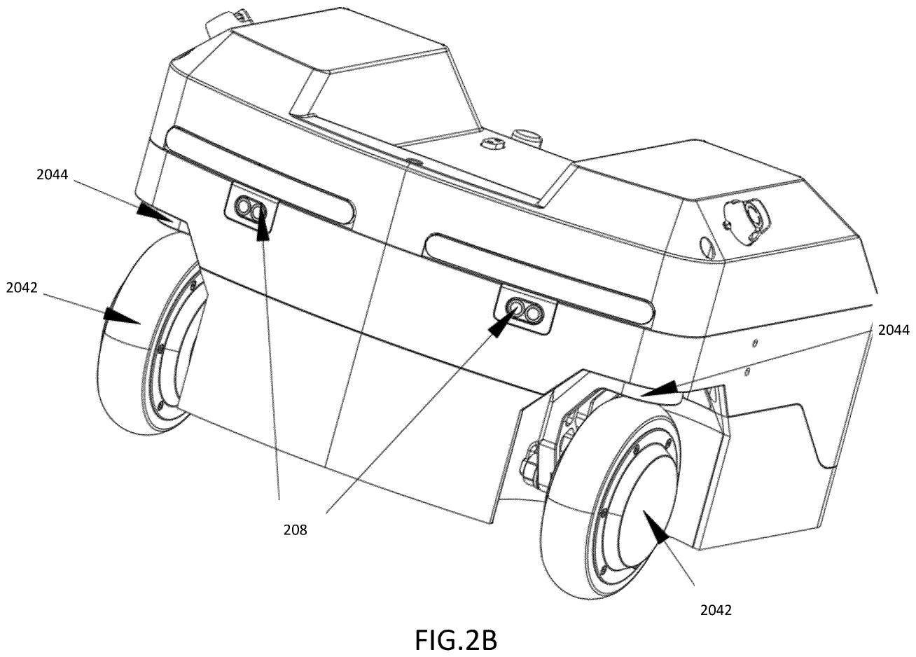

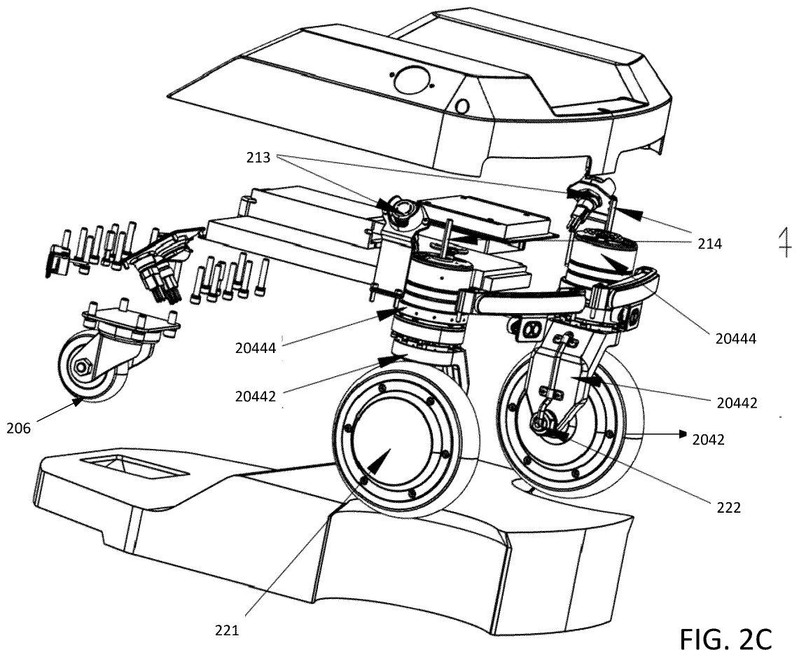

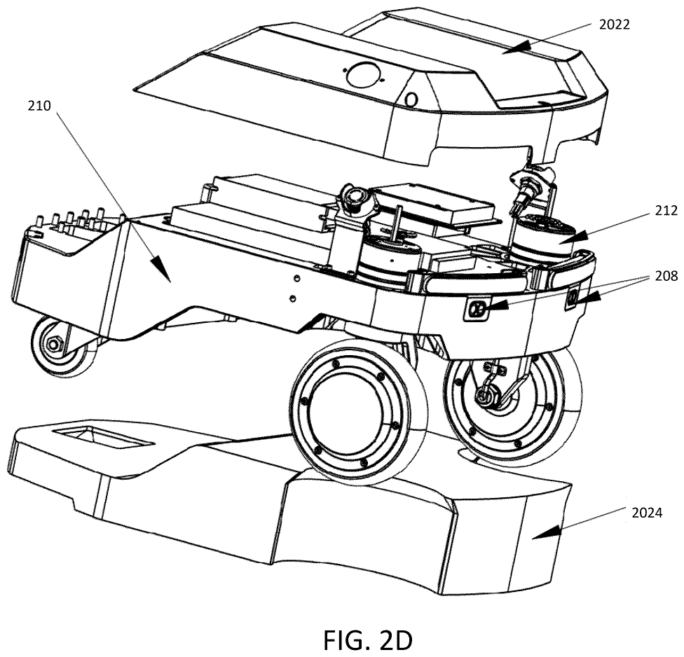

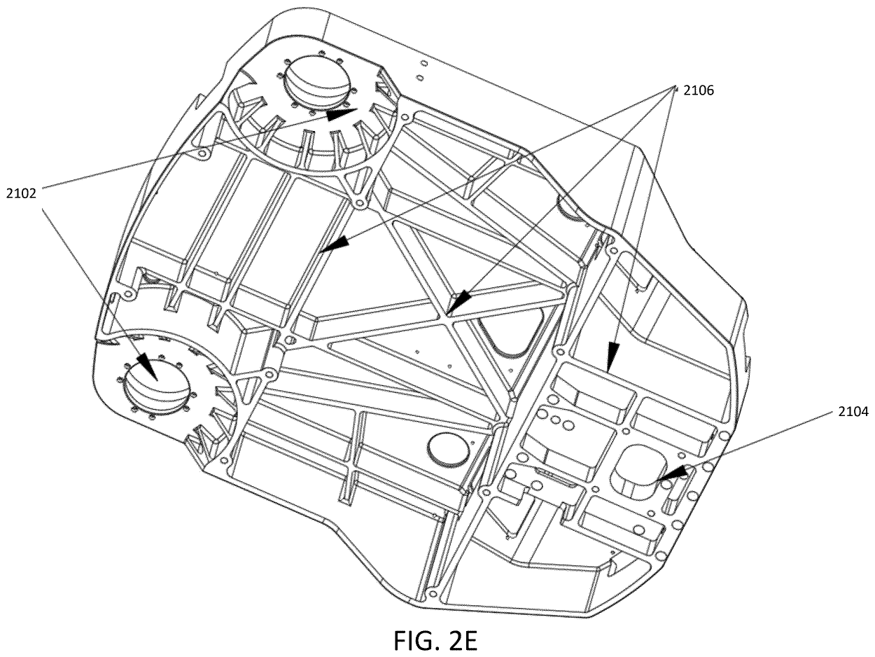

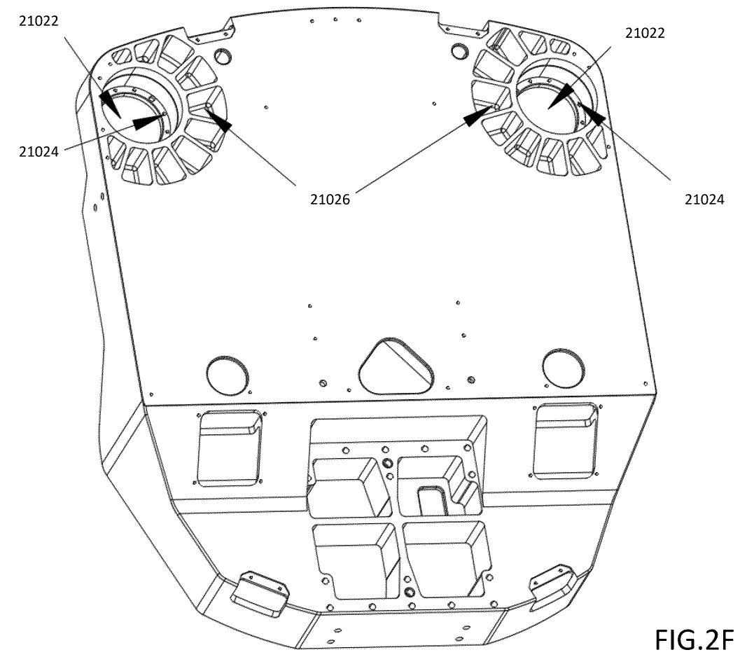

FIGS. 2A-2F illustrate an example of a wheel base 102 for a robotic system in accordance with the present disclosure. Various components of the example of the wheel base 102 will be described with reference to FIGS. 2A-2F continuously. As shown in FIGS. 2A and 2D, the example of the wheel base 102 has a base bracket 202, active wheel assemblies 204, a passive wheel assembly 206, a cross-bearing seat 210, one or more obstacle avoidance sensors 208, and/or any other components.

The base bracket 202 is a structural component of the robotic system 100. The base bracket 202 is a primary structure to which the example of the wheel base 102 are attached and supported. In implementation, the base bracket 1 can comprise a lower shell 2024 and an upper cover 2022, shown in FIG. 2D. The lower shell 2024 serves as a base for attaching the example of the wheel base 102 and the cross-bearing seat 210. The upper cover 2022 fits over the cross-bearing seat 504 and the lower shell 2024. The lower and upper shells 2022 and 2024 can be secured together using one or more threaded fasteners to form the base bracket 202. The base bracket 202 is designed to provide a stable base for the robotic system 100, supporting both active and passive wheel assemblies 204 and 206.

In this example, wheel base 102 incorporates both active and passive wheel assemblies, 204 and 206, to achieve mobility. The active wheel assemblies 204 provide a driving force and steering capabilities, while the passive wheel assembly 206 offers stability and support.

In this example, the active wheel assemblies 204 are located at a front of the base bracket 202 and two active assemblies 204 are shown. It should be understood that this is not intended to be limiting. For example, the location of active wheel assemblies 204 on the wheel base 102 may vary in some other examples, for instance at a middle or rear portion of the wheel base 102. The number of the active assemblies 204 may vary in some other examples, for instance, 1, 3, 4 and so on. In general, the active wheel assemblies 204 may be positioned on the wheel base to achieve good mobility and/or maneuverability for the robotic system 100.

As shown in FIG. 2B, in various implementation, a given active wheel assembly 204 may include a steering motor group 2044 and a hub motor group 2042. In this example, for the right/left active wheel assembly 204, the steering motor group 2044 is situated on top of the corresponding hub motor group 2044 and is responsible for rotating the corresponding entire hub motor group 2044 to achieve directional changes. FIG. 2C illustrates one example implementation for the active wheel assemblies 2042. In that example, the steering motor group 2044 comprises a steering bracket 20442, a steering motor component 20444. The steering bracket 20444 connects to the hub motor group 2042 and the steering motor component 20444 passes through the steering bracket 20444 to connect with the hub motor group 2042. A central control encoder 213 and a central control wire set 214 are located near the steering bracket 20442. The central control wire set 214 connects to the hub motor group 2042, runs through the steering motor component 20444 and connects to the central control encoder 213. The hub motor group 2042 is responsible for propelling the robot forward. In implementation, the hub motor group may include a stator 222 and a rotor 221.

In this example, the passive wheel assembly 206 is located at a rear of the base bracket 202. It should be understood that this is not intended to be limiting. For example, the location of passive wheel assemblies 206 on the wheel base 102 may vary in some other examples, for instance at a middle or rear portion of the wheel base 102. The number of the passive assembly 206 may vary in some other examples, for instance, 2, 3, 4 and so on. In general, the passive wheel assemblies 204 may be positioned on the wheel base 102 to achieve good weight distribution for the robotic system 100.

The passive wheel assembly 206 provides stability and support to the wheel base 102. The passive wheel assembly 206 may be a universal wheel, which means it can rotate freely in any direction. This allows the robotic system 100 to move smoothly without the need for another steering mechanism. In this example, the active wheel assemblies 204 and the passive wheel assembly 206 are arranged to form an equilateral triangle, further enhancing the robot's stability and maneuverability. It should be understood that although it is shown in this example that the wheel assemblies are arranged as an equilateral triangle, this is not intended to be limiting. In some other examples, they may be arranged as substantially equilateral to enhance stability. In general, a multi-wheel system in this example ensures stable support on uneven terrain by leveraging the geometric principle that three points define a plane. This guarantees that the chassis maintains constant contact with the ground, providing a rigid and reliable foundation.

However, a balance should be considered when selecting a number of wheels on the chassis for the wheel base. For example, a four-wheel design may encounter difficulties when navigating uneven surfaces. Since the ground is never perfectly flat, it is difficult to ensure that all four wheels always remain in contact with the surface. This often results in one wheel being suspended, reducing the chassis'overall stability and compromising support for the robot.

To address this issue, a four-wheel system would require a suspension system (similar to those used in automobiles) to compensate for variations in terrain and maintain consistent ground contact. However, implementing a suspension system introduces several drawbacks. First, it increases the size of the chassis, occupying more space. Second, it raises manufacturing and maintenance costs, making the robot more expensive. Third, and most critically, a suspension system introduces vertical oscillation when the robot moves. This is particularly problematic when the robot's upper body is tall or carrying a heavy object, as the chassis will experience noticeable up-and-down movement, reducing stability and precision.

In this example, a three-wheel configuration is selected. The three wheels, as shown, are arranged in an equilateral triangular formation along the outer edge of the chassis, eliminates these issues. By ensuring rigid three-point support, this design provides a stable, reliable foundation without requiring a complex suspension system. This design offers several key advantages: improved stability, as the robot maintains a firm and consistent connection with the ground; no vertical oscillation, allowing for smoother movement and greater precision; and lower cost and structural simplicity, making it more efficient in terms of both design and performance.

In this example, the cross-bearing seat 210 is positioned between the lower shell 2022 and upper cover 2024 of the base bracket 202 and provides additional support for the robotic system 100. The cross-bearing seat 210 serves as a mounting platform for the active wheel assemblies 204, the passive wheel assembly 206, and other components, contributing significantly to the stability and functionality of the robotic system 100.

In accordance with the present disclosure, the cross-bearing seat 210 features several design considerations. FIG. 2E illustrates one implementation of the cross-bearing seat 210. As shown in FIG. 2E, the cross-bearing seat 210 includes active wheel mounting positions 2102, a passive wheel mounting position 2104, reinforcement ribs 2106, and/or any other components. FIG. 2F shows the active wheel mounting position 2102 can be equipped with a mounting hole 21022, a fixed ring 21024), a reinforced area 21026, and/or any other features. The steering motor component 20444 of the active wheel assembly 204 is placed in the mounting hole 2102 and connects to the fixed ring 2104. The reinforced area 21026, which is a multi-hole reinforced structure, is located around the fixed ring 2104, increasing its surface area for better support and strength. The cross-bearing seat 210 also has multiple reinforcing ribs 2106 on its bottom surface. These reinforcing ribs 2106 enhance the structural integrity and stability of the cross-bearing seat.

In addition to supporting the active and passive wheel assemblies 204, 206, the cross-bearing seat 210 also accommodates one or more obstacle avoidance sensors 208, which may be placed on the cross-bearing seat 210 and are positioned between the cross-bearing seat 210 and the upper cover. The cross-bearing seat 210 can serve as a platform for mounting electrical components such as circuit boards and batteries. The design of the cross-bearing seat 210 optimizes space utilization within the base bracket 202, providing a compact and stable structure for the robot's operation. The lower shell 2022, the cross-bearing seat 210 and the upper cover 2024 are fixed together using screws.

In this example, the cross-bearing seat 210 is configured to load one or more batteries enabling robots to work for long operation time per charge. This design allows robotic system 100 to be put on more powerful motors so it may have higher performance. For example, this enables the robotic system 100 to have motors with very high torque density, and to lift heavy objects, making robots more useful in different applications. This design also makes the base more stable as there are more weight on the base, and this lowers the center of mass of the robot. This greatly improves the stability and safety of the robot.

In summary, the cross-bearing seat 210 is an important component of the wheel base 102, providing a stable and versatile platform for mounting the active/passive wheel assemblies 204/206, obstacle avoidance sensors 208 sensors, and other components. Its structural design, including the mounting positions, reinforced area, and reinforcing ribs, contributes to the overall stability and functionality of the robotic system. In this design, these components (reinforced areas and reinforcing ribs) play a crucial role in enhancing the strength and rigidity of structural strength of the robotic system 100. These reinforcements are strategically placed. Considerations include incorporating primary and secondary reinforcing ribs, along with transverse reinforcements, to enhance the robotic system 100's rigidity, load-bearing capacity, and resistance to lateral deformation. The transverse ribs connect multiple longitudinal ribs to prevent lateral deformation, increasing the overall strength of the vehicle's structure

In this example, the robotic system 100 incorporates obstacle avoidance sensors 208 as part of its sensing system. These components are placed on the cross-bearing seat 210, located between the cross-bearing seat 210 and the upper cover 2022 of the base bracket 202. This placement allows the sensors to effectively monitor the surrounding environment and detect obstacles, thereby enhancing the robotic system 100's ability to navigate safely and autonomously.

In various implementations, the obstacle avoidance sensors 208 may employ infrared technology. The infrared sensors work by emitting infrared light and then detecting the reflected light. When an object is present within the sensor's detection range, the infrared light bounces back to the sensor, which then signals the robot's control system about the presence of an obstacle. This detection mechanism allows the robotic system 100 to avoid collisions with objects in its path. The sensors are typically integrated with the robotic system 100's control system, enabling the robotic system 100 to respond dynamically to its surrounding.

In some implementations, the obstacle avoidance sensors 208 use the intersection of the fields of view of the emitter and the receiver to define a sensitive volume. An object within this volume reflects light from the transmitter to the receiver. In those implementations, the obstacle avoidance sensors 208 are designed to minimize interference from background lighting by using infrared filters and detecting pulsed signals from the emitter. The emitters are typically gallium arsenide diodes that emit at a wavelength of 940 nm and can pulse with a current of several amperes for a few microseconds. The receivers can be PIN photodiodes housed in black moldings that are transparent to infrared but absorb visible light.

In summary, the infrared obstacle avoidance sensors 208 are important for the robotic system 100's autonomous navigation. They are placed on the cross-bearing seat 210 and can use infrared technology to detect the presence of obstacles, enabling the robotic system 210 to make informed decisions and navigate its environment safely.

### Height Adjustment System

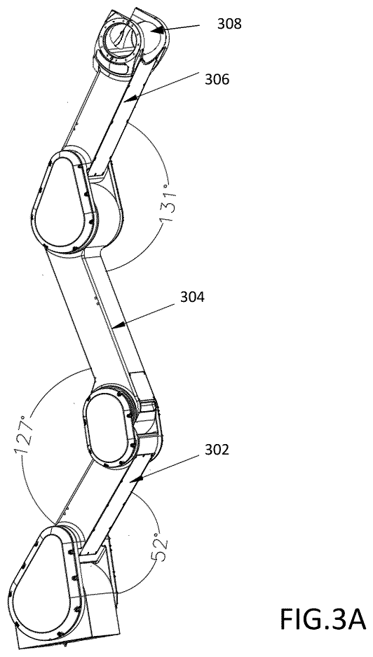

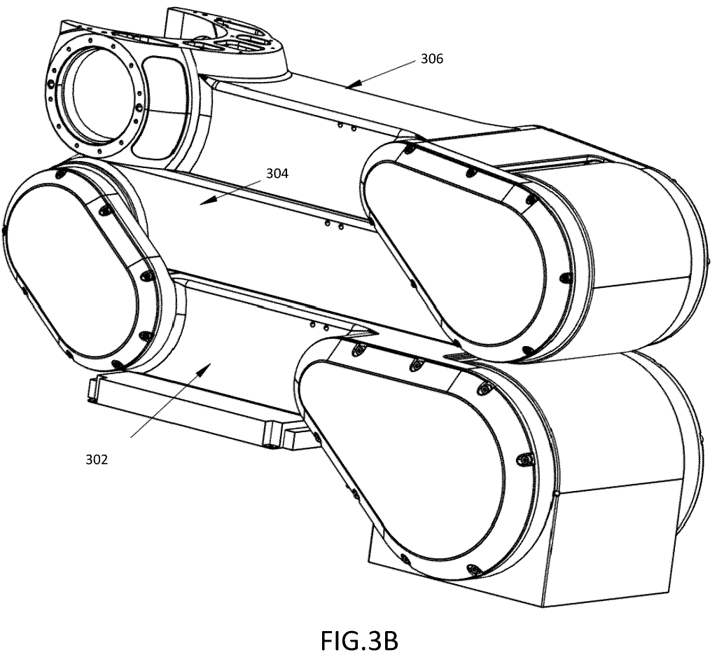

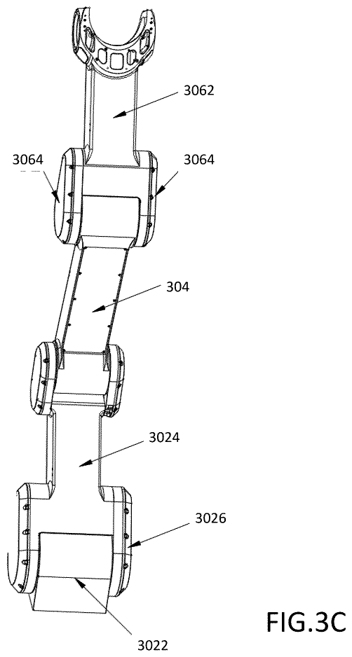

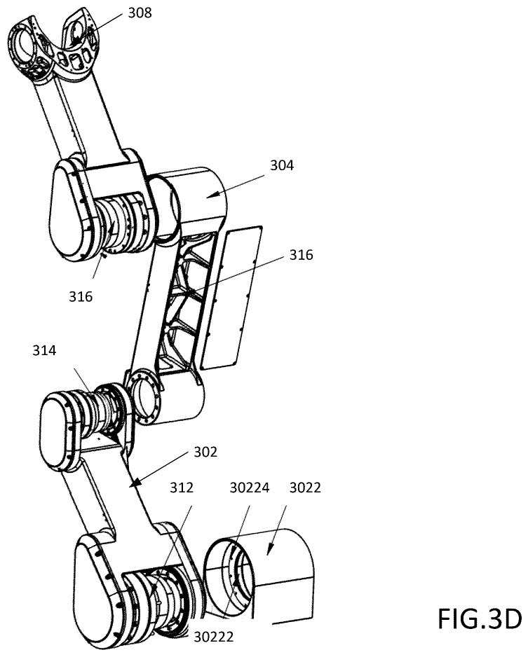

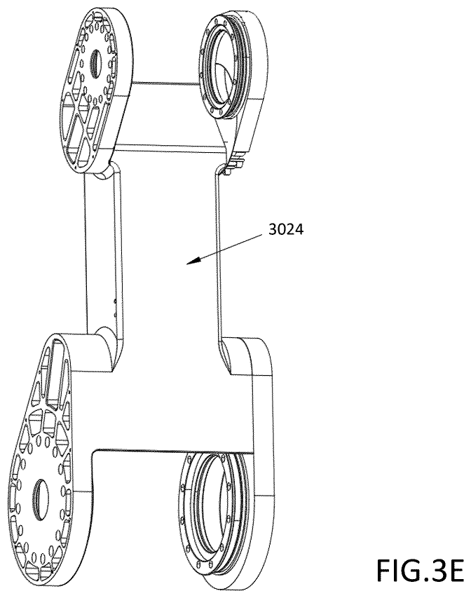

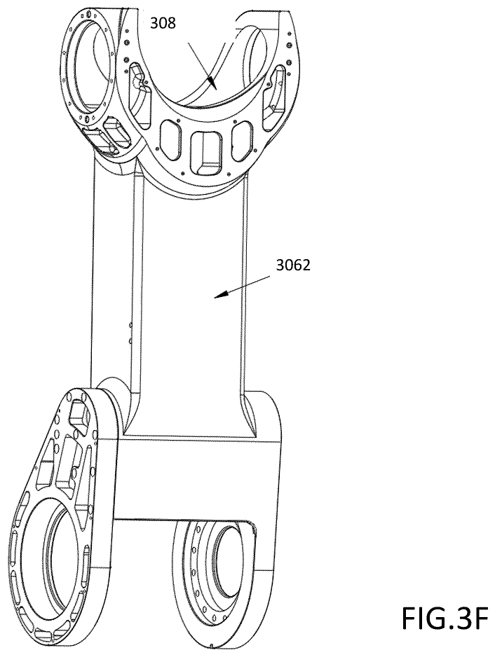

Attention is now directing back to FIG. 1. The height adjustment system 104 shown in FIG. 1 is a novel, foldable, and retractable lifting structure designed for compact storage and enhanced stability of the robotic system 100. This structure employs a multi-stage design with multiple nested connections, aiming to minimize space usage and ensure stability during operations of the robotic system 100. FIGS. 3A-F illustrate an example of the height adjustment system 104, which will described with reference to those figures continuously.

FIG. 3A generally illustrates the example of the height adjustment system 104. As can be seen, in this example, the height adjustment system 104 has three connecting assemblies 302, 304, and 306, and a receiving space 308. It should be understood that although three connecting assemblies are shown in this example, this is not intended to be limiting. The number of connecting assemblies in a height adjustment system for a robotic system in accordance with the present disclosure is not intended to be limited to three. It is understood that in some other examples, the number of the connecting assemblies may vary, for example 1, 2, 4, 5 and so on.

The first connecting assembly 302 is a base of the structure and is configured to connect with the wheel base 102. FIG. 3C illustrates one example implementation of the first assembly 302. As can be seen in that implementation, the first assembly 302 comprises a first base 3022, a first connecting shell 3024, and a first fixed shell 3026. FIG. 3D shows further details of the first assembly 302. As can be seen from FIG. 3D, the first base 3022 is cylindrical and features a fixed bearing 30222 with a through-hole 30224, which is used to attach the first motor reducer module 312. The first connecting shell 3024 is U-shaped at both ends and has a hollow center with reinforcing ribs, as shown in FIG. 3E. It connects to the first motor reducer module 30226 at the bottom and to the second motor reducer module 314 at the top. The first fixed shell 3026 is designed to fit onto the outside of the first connecting shell 3024 to secure the first assembly 302.

The second connecting assembly 304 acts as an intermediate component, linking the first and third assemblies 302 and 306. It has a cylindrical shape at both ends, where the second motor reducer module 314 and third motor reducer module 316 are installed.

The third connecting assembly 306 is positioned at a top of the of the height adjustment system 104 and is designed to accommodate various attachments such as a gimbal assembly 106 or a robot arm. It includes a second connecting shell 3062 and a second fixed shell 3064. The second connecting shell 3062 is U-shaped and connects to the third motor reducer module 316 at one end. The other end forms a receiving space for the gimbal assembly 106. The second fixed shell 3064 is designed to be fixed on the outside of the connecting ends of the second connecting shell 3062.

In this implementation, the height adjustment system 104 employs three motor reducer modules (312, 314, and 316) to enable rotational movement of the connecting assemblies, thus facilitating extension and retraction. The first motor reducer module 312 drives the rotation of the first connecting shell 3024 relative to the first base 3022 within a range of 0 to 60°. In this design, careful consideration was given to a first joint of the height adjustment system 104, which needs a significant amount of torque due to the larger and heavier motor involved. To enhance stability, this design aims to position the motor as low as possible on the chassis. By lowering the overall center of gravity, the robotic system 100 can maintain better balance during movement, especially when performing complex actions or making turns.

The concept of ‘0 degrees’ is critical for allowing the robotic system 100 waist joint to achieve a horizontal state, which facilitates a folding posture of the waist. However, it's important to note that the upper limit for this joint's motion is not restricted to 60 degrees; in fact, the maximum range of motion can be up to 100 degrees in some other examples.

When positioned at approximately 52 degrees, the robot's waist can extend upwards to its highest state while ensuring that its overall center of gravity remains within the circular area formed by the three wheels of the chassis. This configuration contributes to a stable design. Therefore, the 52-degree angle shown in FIG. 3A serves merely as an illustration of the 100 in an extended state rather than a limitation on its joint movement.

The second motor reducer module 314 drives the rotation of the second connecting assembly 304 relative to the first connecting shell 3024, with a rotational range of 0 to 140°. The third motor reducer module 314 controls the rotation of the second connecting shell 3062 relative to the second connecting assembly 304, also with a rotational range of 0 to 140°.

FIG. 3B illustrates one example of a retracted state for the height adjustment system 104. As can be seen, in this example, all three connecting assemblies 302, 304, and 306 are horizontally aligned, minimizing the space occupied. When expanded, the angles between the first and second connecting assemblies 302, 304 and the second and third connecting assemblies 304, 306 range from 100 to 160°. As an example, the angle between the first and second connecting assemblies is 127°, and the angle between the second and third connecting assemblies is 131°. It should be understood that a maximum range of motion for the second joint (counting from the bottom up) can be actually up to 200 degrees, and a maximum range of motion for the third joint can also be up to 200 degrees. The 127 degrees and 131 degrees shown in the figures are not intended to be limiting. FIG. 3A shows one extended state of the robotic system 100, where the first joint is around 52 degrees, the second joint is around 127 degrees, and the third joint is around 131 degrees. In this configuration, the robotic system 100's torso can extend upwards and forwards to its maximum reach while ensuring that the robot's center of gravity remains within the base area, providing stability. Therefore, what is shown is a feasible angle arrangement that allows the robot to reach its highest point while maintaining stability.

This foldable feature of robotic system 100 is novel and makes the robotic system 100 easy to be transported. For example, in a retracted state described above, the robotic system 100 can be stored in a trunk of a vehicle such as an SUV. In various examples, torsos of the robotic system 100 may also be folded into a compact state to facilitate portability of the robotic system 100.

The internal reinforcing rib 316 shown in FIG. 3D is located within the second connecting assembly 304. These reinforcing ribs 316 is designed to enhance the structural stability of the height adjustment system 104. As mentioned, the second connecting assembly 302 is a cylindrical component that acts as an intermediate link between the first connecting assembly 302 and the third connecting assembly 306. The internal reinforcing rib 316 helps to maintain the shape and integrity of this component, particularly when the lifting structure is in operation.

The receiving space 308 is configured to accommodate components like the gimbal assembly 106, or a robot limb. The receiving space 308 may be formed by one of the U-shaped ends of the second connecting shell 3062. The receiving space 308 allows the gimbal assembly 106 or similar component to be stored within the structure when it's in a retracted state as shown in FIG. 3B. This design feature is important for achieving a minimal overall size when the height adjustment system 104 is folded, making it more portable and easier to store. The second connecting shell 3062 is able to rotate relative to the second connecting assembly 304, driven by the third motor reducer module 316. By positioning the receiving space 308 at the top of height adjustment system 104, the design allows for both the mounting of gimbal assembly 106 and its subsequent storage, combining functionality with space efficiency.

The design of the height adjustment system allows for both protection of the camera lens and a reduction in overall size. The component has a wide range of movement with horizontal and pitch adjustments, expanding the visual recognition range of the system. The dual-layer, multi-angle system uses a base layer for horizontal rotation of 360° and an upper layer for 180° pitch adjustment.

### Gimbal Assembly

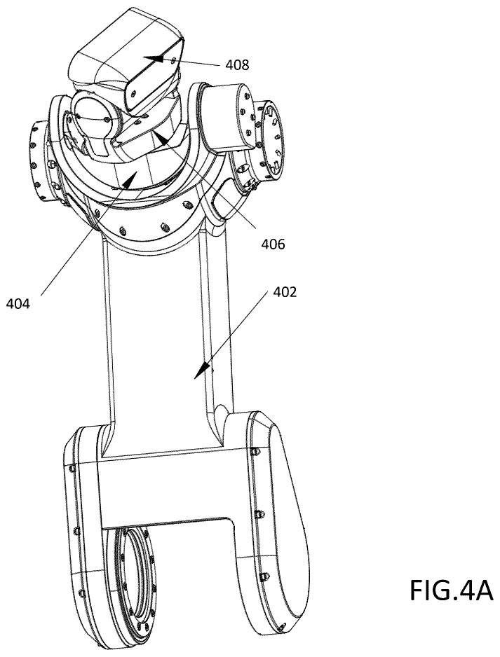

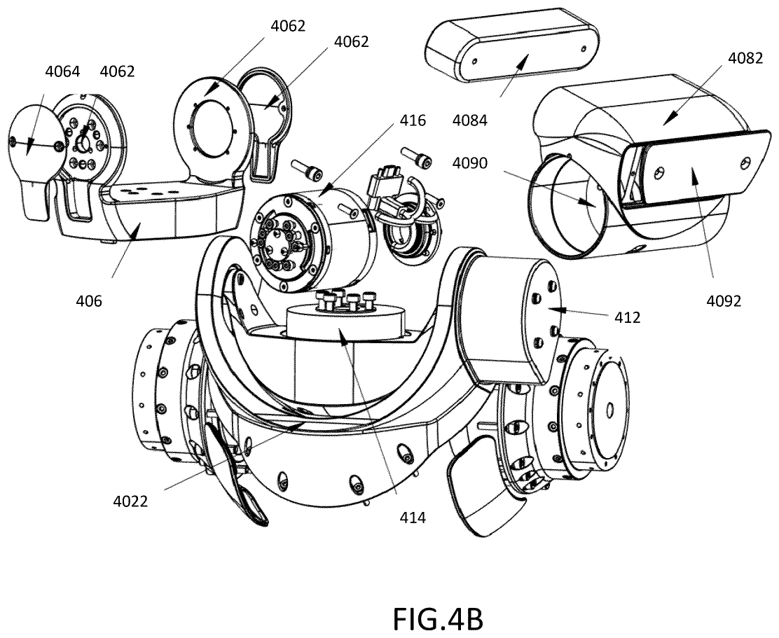

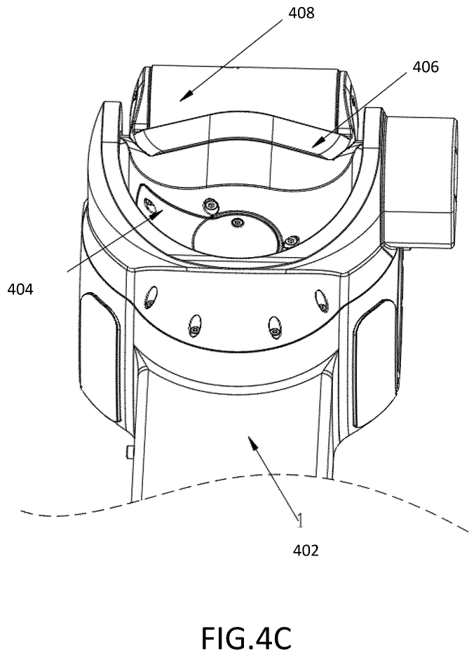

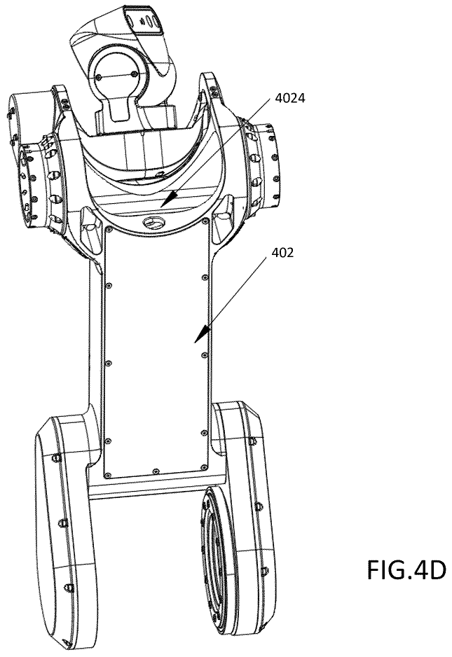

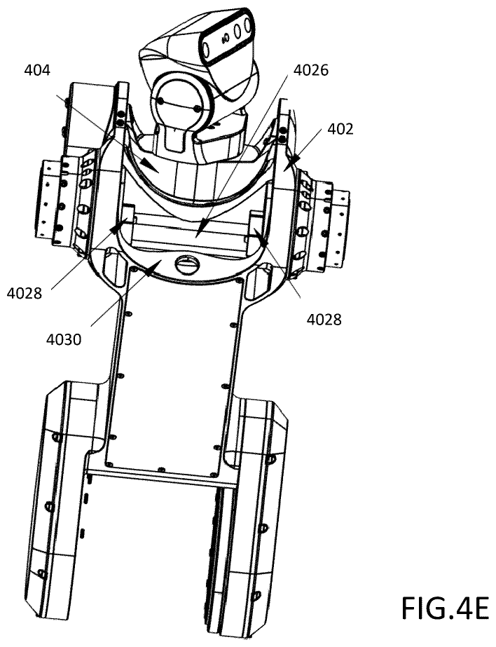

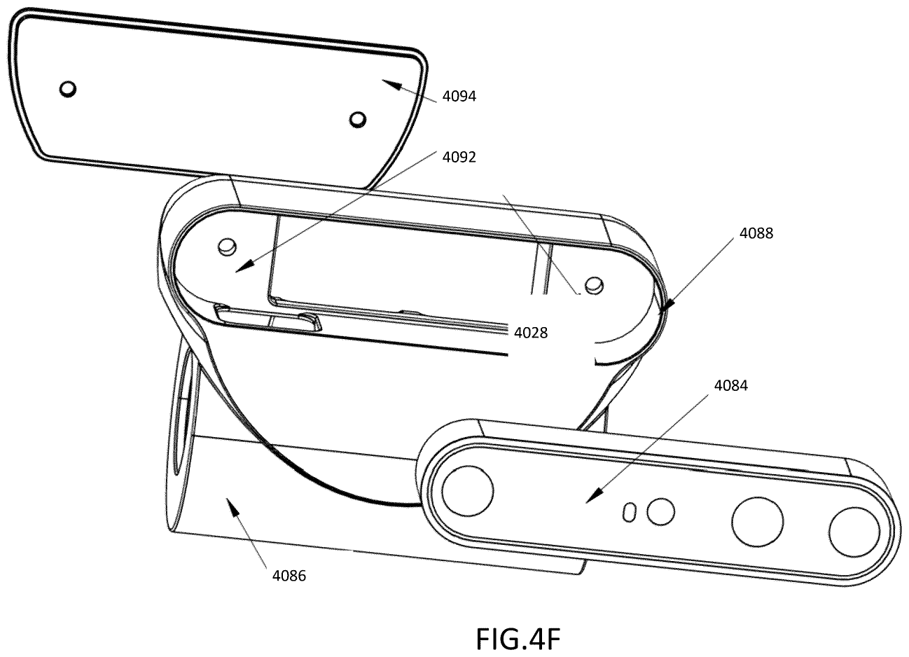

Attention is now directed back to FIG. 1. The gimbal assembly 106 is designed to facilitate versatile viewing angles for the robotic system 100 and for compact storage of the robotic system 100. The foldable design of the gimbal assembly 106 also allows for protection of a vision module (such as a camera) employed by the robotic system 100, while also reducing the overall size for transport and storage for the robotic system 100. The gimbal assembly 106 is designed with a cylindrical support structure to fix the third driving element within it, making the structure compact and stable. FIGS. 4A-F illustrate one example of the gimbal assembly 106, which will be described with reference to those figures continuously.

FIG. 4A illustrates generally the example of gimbal assembly 106. As shown in FIG. 4A, the gimbal assembly 106 includes a support base 402, a first support body 404, a second support body 406, and a gimbal module 408. The gimbal module 408 is driven by a series of driving elements, which allow for a wide range of motion and adjustment.

FIG. 4B illustrates more detail for the example of the gimbal assembly 106 shown in FIG. 4A. As shown, the gimbal assembly 106 includes a first driving element 410 that facilitates the forward and backward flipping of the first support body 404, enabling the second support body 406 and gimbal module 408 to transition between flat and vertical positions. The gimbal assembly 106 includes a second driving element 412 allows for the horizontal rotation of the second support body 406, which adjusts the horizontal viewing angle of the gimbal module 408. The gimbal assembly 106 includes a third driving element 414 that enables the forward and backward rotation of the gimbal module 408, controlling its pitch angle. This dual-layer, multi-angle system allows for a wide visual recognition range. The base layer allows for 360° horizontal rotation, while the upper layer allows for 180° pitch adjustment.

As also shown in FIG. 4B, the support base 402 has a first slot 4022 and a second slot 4024, positioned proximate to each other. In this example, the first slot 4022 is a curved recess, and the bottom of the first support body 404 is curved to match it, allowing for smooth rotation and minimizing space. The second slot 4024 includes a receiving section 4026, shown in FIG. 4E, a limiting section 4028, and a support section 4030. The receiving section 4026 has a curved inner wall, which allows the camera lens on the gimbal module to face downwards for protection when the unit is folded. The limiting section 4028 prevents the lens from touching the inner wall, and the support section 4030 provides further support to the gimbal module's support base.

The second support body 406 has a flat bottom and is connected to the first support body 404 by the second driving element 412. The upper portion of the second support body 406 is U-shaped, with connecting ears 4062 on both sides. These connecting ears 4062 are connected to the gimbal module 408 via the third driving element 414. The connecting ears 4062 are also fitted with fastening pieces 4064 for extra protection. The gimbal module 408 itself consists of a gimbal support 4082 and a visual module 4084. The gimbal support 4082 is connected to the second support body 406 by the third driving element 414, and the visual module 4084 is situated above it as shown. The gimbal support 4082 has a motor mounting part 4086 and a module mounting part 4088. The third driving element 414 fits into the motor mounting part 4086, which is cylindrical and has a motor fixing bearing 4090 in the middle. The module mounting part 4088 is a square casing with fixing blocks 4092 on both ends to secure the visual module 4084, with a rear cover 4094 for additional protection.

This foldable design of the gimbal assembly 106 allows for protection of the camera lens, while also reducing the overall size for transport and storage. The gimbal module 410 is designed with a cylindrical support structure to fix the third driving element within it, making the structure compact and stable. The gimbal assembly 106 is designed to be foldable for storage when not in use. This feature is important because it protects the camera lens on the visual module 4084 when the device is being stored or transported. The first driving element 410 is used to drive the first support body 402 to flip backwards. This action allows the gimbal module 408 to be placed into the second slot 4024. This not only protects the camera lens but also reduces the overall height of the component.

Any of the computer systems mentioned herein may utilize any suitable number of subsystems. Examples of such subsystems are shown in FIG. 10 in computer system 10, which can be configured to implement various features and/or functions described herein. In some embodiments, a computer system includes a single computer apparatus, where the subsystems can be the components of the computer apparatus. In other embodiments, a computer system can include multiple computer apparatuses, each being a subsystem, with internal components.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary. The use of “or” is intended to mean an “inclusive or,” and not an “exclusive or” unless specifically indicated to the contrary.

Two states are also for illustration purpose. It is possible for an embodiment where remote command and local command for changing oxygen device settings be accepted without state switches.

All patents, patent applications, publications, and descriptions mentioned herein are incorporated by reference in their entirety for all purposes. None is admitted to be prior art.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A robotic system comprising a wheel base, a height adjustment system, and a gimbal assembly, wherein:
the wheel base comprises an active wheel assembly and a passive wheel assembly, wherein the active wheel assembly is configured to drive the robotic system, and the passive wheel assembly is configured to facilitate a weight distribution of the robotic system, the active wheel assembly and passive wheel assembly enabling the robotic system to move in multiple directions, wherein one or more active wheels in the active wheel assembly have a same distance to one or more passive wheels in the passive wheel assembly;
the height adjustment system comprises a lifting structure for adjusting a height of the robotic system, wherein the lifting structure comprises multiple connection assemblies configured to have a rotational movement, the multiple connection assemblies including a first connection assembly having a first rotational movement, a second connection assembly having a second rotational movement and a third connection assembly having a third rotational movement, the first, second and third connection assemblies enabling the lifting structure to be in a compact state and an extended state; and,
the gimbal assembly comprises a support body and a gimbal module, wherein the support body facilitates the gimbal module to transition between flat and vertical positions.

2. The robotic system of claim 1, wherein the active wheel assembly has two active wheels and the passive wheel assembly has one passive wheel.

3. The robotic system of claim 2, wherein the active wheels and the passive wheels form an equal-lateral triangle.

4. The robotic system of claim 1, wherein wheel base comprises a cross-bearing seat configured to load one or more batteries, the cross-bearing seat being positioned between a lower shell and an upper shell of the wheel base.

5. The robotic system of claim 4, wherein the cross-bearing seat comprises an reinforced area and one or more reinforcing ribs configured to facilitate the loading of the one or more batteries.

6. The robotic system of claim 1, wherein the first connecting assembly is configured to connect with the wheel base, and comprises a first motor reducer module.

7. The robotic system of claim 1, wherein the second connecting assembly is configured to link the first and third connecting assemblies and comprises a second motor reducer module.

8. The robotic system of claim 1, wherein the third connecting assembly is positioned at a top of the of the height adjustment system and is configured to accommodate the gimbal assembly.

9. The robotic system of claim 1, wherein when in the compact state, angles between the first, second and third connecting assemblies are substantially 0 degrees.

10. The robotic system of claim 1, wherein when in the extended state, angles between the first, second and third connecting assemblies are substantially 200 degrees.

11. The robotic system of claim 1, wherein the gimbal assembly comprises a first driving element that facilitates a forward and backward flipping of the support body.

12. The robotic system of claim 11, wherein the gimbal assembly comprises a second driving element that facilitates an adjustment of a horizontal viewing angle of the gimbal module.

13. The robotic system of claim 11, wherein the gimbal assembly comprises third driving element that enables a forward and backward rotation of the gimbal module for a pitch angle.
